(19) United States
(12) Patent Application Publication
(10) Pub. No.: US 2011/0137724 A1
(43) Pub. Date: Jun. 9, 2011

(54) METHOD, SYSTEM AND APPARATUS FOR ADVERTISEMENT DELIVERY FROM ELECTRONIC DATA STORAGE DEVICES

(75) Inventors: Amit Ramchandran, San Jose, CA (US); Amir Masoud Zarkesh, Saratoga, CA (US)

(73) Assignee: iCelero LLC, San Jose, CA (US)

(21) Appl. No.: 12/963,306

(22) Filed: Dec. 8, 2010

Related U.S. Application Data
(60) Provisional application No. 61/285,117, filed on Dec. 9, 2009.

(51) Int. Cl. G06Q 30/00

(52) U.S. Cl. 705/14.49

(57) ABSTRACT

A system, method and computer program product for delivering advertisements via electronic data storage devices, including an electronic data storage device, including a memory, a controller processor, and a pre-loaded target advertisement; and a host device coupled to the electronic data storage device. The controller processor or an additional processor is configured to deliver the target advertisement to the host device by inserting or overlaying the target advertisement in a target file as the host device reads the target file from the electronic data storage device.

### CROSS REFERENCE TO RELATED DOCUMENTS

The present invention claims benefit of priority to U.S. Provisional Patent Application Ser. No. 61/285,117 of Amit RAMCHANDRAN et al., entitled “METHOD AND APPARATUS FOR ADVERTISEMENT DELIVERY FROM ELECTRONIC DATA STORAGE DEVICES,” filed on Dec. 9, 2009, the entire disclosure of which is hereby incorporated by reference herein.

### BACKGROUND OF THE PRESENT DISCLOSURE

1. Field of the Present Disclosure

The present disclosure generally relates to advertisement systems and methods, and more particularly to systems and methods for delivering advertisements via electronic data storage devices, and the like.

2. Discussion of the Background

In recent years, systems and methods for electronic delivery of advertisements have become widespread. However, even with such advertisement systems and methods, there is still a need for systems and methods for delivering advertisements via electronic data storage devices, and the like.

### SUMMARY OF THE PRESENT DISCLOSURE

Therefore, there is a need for a method and system that address the above and other problems with advertisements systems and methods. The above and other needs are addressed by the illustrative embodiments of the present disclosure, which provide a novel method, system and apparatus for delivering advertisements via electronic data storage devices, and the like.

Accordingly, in an illustrative aspect, there is provided a system, method and computer program product for delivering advertisements via electronic data storage devices, including an electronic data storage device, including a memory, a controller processor, and a pre-loaded target advertisement; and a host device coupled to the electronic data storage device. The controller processor can be configured to deliver the target advertisement to the host device by inserting or overlaying the target advertisement in a target file as the host device reads the target file from the electronic data storage device.

The target advertisement can be one of a text file, a picture file, an audio file, and a video file, and the target file is one of a document file, a picture file, an audio file, a music file, a video file, and a game file.

A processor of the host device need not be used for the inserting or the overlaying of the target advertisement in the target file.

The target advertisement inserted or overlaid in the target file is compliant with a file format of the target file and if the target file is not compatible with the host device, the controller processor is configured to transcode the target file to allow playback on the host device.

The controller processor can be configured to analyze the target file to determine one of metadata, and tags for the target file.

An additional processor instead of the controller processor can be provided and configured to deliver the target advertisement to the host device by inserting or overlaying the target advertisement in a target file as the host device reads the target file from the electronic data storage device.

Still other aspects, features, and advantages of the present disclosure are readily apparent from the following detailed description, simply by illustrating a number of illustrative embodiments and implementations, including the best mode contemplated for carrying out the present disclosure. The present disclosure also is capable of other and different embodiments, and its several details can be modified in various respects, all without departing from the spirit and scope of the present disclosure. Accordingly, the drawings and descriptions are to be regarded as illustrative in nature, and not as restrictive.

### BRIEF DESCRIPTION OF THE DRAWINGS

The embodiments of the present disclosure are illustrated by way of example, and not by way of limitation, in the figures of the accompanying drawings, in which like reference numerals refer to similar elements, and in which:

FIG. 1 is an illustrative system, method and apparatus for delivering advertisements via electronic data storage devices, and the like;

FIG. 2 is an illustrative system, method and apparatus for delivering advertisements via electronic data storage devices, and the like, according to a further illustrative embodiment;

FIG. 3 is an illustrative flow chart for a read process for a file on an electronic data storage device of the illustrative systems of FIGS. 1-2; and

FIG. 4 is an illustrative flow chart for a write process for a file on an electronic data storage device of the illustrative systems of FIGS. 1-2.

### DETAILED DESCRIPTION OF THE PREFERRED EMBODIMENTS

The present disclosure includes recognition that various electronic data storage devices, and the like, have been developed and which can include basic components, such as (1) one or more memory, disk, and the like, components, such as magnetic tapes, magnetic discs, solid state memories, such as flash memories, and the like, and (2) a controller that translates logical set of read/write commands, addresses, and the like, coming through well known industry standard interfaces, and the like, to analog signals, and the like, that accordingly run the target memory, disk, and the like, component.

The data on the electronic data storage devices are processed for read and write by a host system processor to achieve target functionalities. Example host systems can include servers in data centers, personal computers, laptops, netbooks, personal media players, consumer electronic devices, handsets, and the like. Examples of electronic data storage devices can include Magnetic tape, Disk storage, Floppy disk, ZIP disk, Holographic, Optical discs, such as CD, DVD, Blu-ray Disc, Minidisc, Hard disk drive, Magnetic bubble memory, Flash memory/memory card (e.g., solid state semiconductor memory), xD-Picture Card, MultiMedia Card, USB sticks or flash drives, SmartMedia, CompactFlash I and II, Secure Digital (SD) cards, microSD cards, miniSD cards, SDHC cards, miniSDSC cards, Sony Memory Sticks (e.g., Std/Duo/PRO/MagicGate versions), Solid-state drives, and the like.

In an illustrative embodiment, the host system processor is programmable and accesses the electronic data storage device. In a further illustrative embodiment, the controller of the electronic data storage device is programmable as well. Electronic data storage devices can have further functionalities through their programmability, if their performance allows doing new tasks in addition to the basic memory and/or disk control functionality, and the like. Such additional tasks can be done by adding a field and/or programmable processor to the electronic data storage devices. Examples of some additional tasks that can be performed by such electronic data storage systems can include security, digital rights management, compression and decompression, decoding and encoding, post-processing, and the like

Generally, the present disclosure can include a method, system and apparatus for an electronic data storage device, including a memory, disk, and the like, component and a memory, disk, and the like, controller processor, and an optional additional processor(s), with pre-loaded multimedia advertisements, and the like. The controller processor and/or the additional processor can be configured to deliver the target advertisements to the host system, for example, while reading a target file from the electronic storage device, and inserting, overlaying, and the like, the target advertisements in the target file. The target advertisements can be in the form of text, picture, audio, video, and the like, files inserted or overlaid into the target file, in the form of a document, picture, audio, music, video, other file types, and the like, that are stored on the electronic data storage device. The controller processor and/or the additional processor can perform such advertisement delivery without using the processor found in the host system for the advertisement insertion or overlay operations. The advertisement inserted, overlaid, and the like, on the target content file continues to be compliant with the file format of the original file to work with the corresponding application on the host system. In cases where the original file is not compatible with the host device, the original file can be transcoded, adapted, and the like, to allow playback on the host device. Moreover, the present disclosure provides the method, system and apparatus to analyze the target file, including a document, picture, audio, music, video, internet pages, games files, and the like, that a user stores on the electronic data storage device as they are written or read to extract suitable metadata, tags, and the like, for personalized advertisement insertion at the time of reading the target file. The price of the electronic data storage device can be partly or fully subsidized, and the like, or a cash back incentive, and the like, can be provided based on advertisement revenue, and the like. The advertisement content can be updated by replacing the electronic data storage device, by loading new content, and the like.

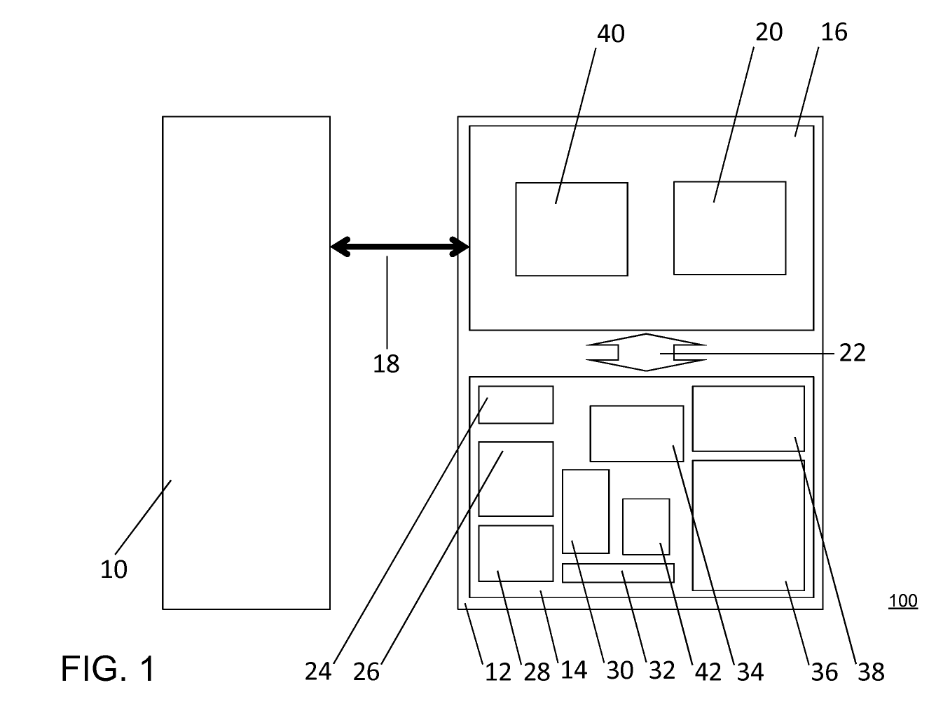

Referring now to the drawings, FIG. 1 is an illustrative system, method and apparatus for delivering advertisements via electronic data storage devices, and the like. In FIG. 1, the illustrative system, method and apparatus 100 can include a host device 10, such as a server in a data center, a personal computer, a laptop, a netbook, a tablet, a personal media player, a consumer electronic device, a handset, a cell phone, and the like. The host device 10 is connected to one or more electronic data storage devices 12 with a suitable connection 18. In an illustrative embodiment, the electronic data storage device 12 can be external to the host device 10. In a further illustrative embodiment, the electronic data storage device 12 can be an internal component, and the like, of the host device 10. Examples of the electronic data storage device 12 can include Magnetic tape, Disk storage, Floppy disk, ZIP disk, Holographic, Optical disc such as CD, DVD, Blu-ray Disc, Minidisc, Hard disk drive, Magnetic bubble memory, Flash memory/memory card (e.g., solid state semiconductor memory), xD-Picture Card, MultiMedia Card, USB sticks or flash drives, SmartMedia, CompactFlash I and II, Secure Digital (SD) cards, microSD cards, miniSD cards, SDHC cards, miniSDSC cards, Sony Memory Sticks (e.g., Std/Duo/PRO/MagicGate versions), Solid-state drives, and the like.

The electronic data storage device 12 can include one or more memories and/or disks 14, and the like, to store data, and at least one controller 16. The controller 16 enables the connection of the electronic data storage device 12 through the connection 18 for performing read, write, and the like, operations on the electronic data storage device 12. In an illustrative embodiment, the electronic data storage device 12 can be configured as a slave to the host device 10.

The controller 16 can include at least one processor 20 to control, translate, and the like, the logical read, write, and the like, commands from the host device 10 to signals suitable for the disks and/or memories 14 of the electronic data storage device 12. The processor 20 also can be used to achieve the present method of providing advertisements from the electronic data storage device 12. However, in further illustrative embodiments, one or more additional processors 40 can be included to achieve the advertisement insertion or overlay operations.

The memory and/or disk 14 can be connected to the controller 16 through the connection 22, which similar to the connection 18, can be used for read, write, and the like, operations. The memory and/or disk 14 can be of one or a combination of various types of memories and/or disks, for example, including Magnetic tape, Disk storage, Floppy disk, ZIP disk, Holographic, Optical disc such as CD, DVD, Blu-ray Disc, Minidisc, Hard disk drive, Magnetic bubble memory, Flash memory/memory card (e.g., solid state semiconductor memory), xD-Picture Card, MultiMedia Card, USB sticks or flash drives, SmartMedia, CompactFlash I and II, Secure Digital (SD) cards, microSD cards, miniSD cards, SDHC cards, miniSDSC cards, Sony Memory Sticks (e.g., Std/Duo/PRO/MagicGate versions), Solid-State Drives, and the like.

The electronic data storage device 12 in its typical use by a user and in connection with host device 10 can save one or more files 24-38 and 42 on the memory and/or disk 14 with varying file types, formats, and the like. For example, the one or more files 24 can include audio, voice, music files, and the like, in various standard or non-standard formats, and for example, including AIFF, WAV, AU container format or as RAW audio format, Audio Interchange File Format (AIFF, audio container format), WAV Microsoft “WAVE”, Pulse-density modulation (PDM), Direct Stream Digital (DSD) is standard for Super Audio CD, Pulse-amplitude modulation (PAM), Apple Lossless Audio Codec (ALAC), FFmpeg, QuickTime, Direct Stream Transfer (DST), MPEG-4 DST reference software (ISO/IEC 14496-5:2001/Amd.10:2007), Dolby TrueHD Optional lossless surround sound format used by HD DVD and Blu-ray, it uses MLP but adds higher sample rates, bit rates, and more channels, DTS-HD Master Audio Optional lossless surround sound format used by HD DVD and Blu-ray, it was previously known as DTS++ and DTS-HD, Free Lossless Audio Codec (FLAC), FFmpeg, libFLAC, Lossless Audio (LA), Lossless Predictive Audio Compression (LPAC), Lossless Transform Audio Compression (LTAC), MPEG-4 Audio Lossless Coding (MPEG-4 ALS), MPEG-4 ALS reference software (ISO/IEC 14496-5:Amd 10:Cor 3:2009), MPEG-4 Scalable Lossless Coding (MPEG-4 SLS, also used in audio profile HD-AAC), MPEG-4 SLS reference software (ISO/IEC 14496-5:2001/Amd 10:2007), Meridian Lossless Packing (MLP), also known as Packed PCM (PPCM), it is the standard lossless compression method for DVD-Audio content, Monkey's Audio (APE), OptimFROG (OFR), RealAudio Lossless, RK Audio (RKAU), Shorten (SHN), FFmpeg (decoder only), True Audio (TTA), WavPack (WV), FFmpeg (decoder only), Windows Media Audio 9 Lossless, Adaptive Differential (or Delta) pulse-code modulation (ADPCM, see Pulse-code modulation), ADX, Adaptive Rate-Distortion Optimised sound codeR (ARDOR), Adaptive Transform Acoustic Coding (ATRAC, used in MiniDisc devices), FFmpeg (decoder only), apt-X, Dolby Digital (A/52, AC3), FFmpeg, liba52, DTS Coherent Acoustics (DTS, Digital Theatre System Coherent Acoustics), Impala FORscene audio codec, ITU standards:, G.719, G.722, G.722.1 and G.722.1 Annex C, libg722_{—}1, libsiren (part of libmsn and msn-pecan), G.722.2, 3GPP TS 26.173—AMR-WB speech Codec, opencore-amr (decoder), MPEG-1 Audio and MPEG-2 Audio, layer I (MP1) (MPEG-1, MPEG-2 and non-ISO MPEG-2.5), FFmpeg (decoder only), layer II (MP2) (MPEG-1, MPEG-2 and non-ISO MPEG-2.5), FFmpeg, tooLame, twoLame, layer III (MP3) (MPEG-1, MPEG-2 and non-ISO MPEG-2.5), FFmpeg (decoder only without external library), LAME, Advanced Audio Coding (AAC) (MPEG-2 Part 7), FAAC, FAAD, FFmpeg, iTunes, Nero AAC Codec, MPEG-4 Audio, Advanced Audio Coding (AAC), (MPEG-4 Part 3 subpart 4), HE-AAC, FAAC, FAAD2, FFmpeg (decoder only without external library), iTunes, Nero AAC Codec, MPEG-4 AAC reference software (ISO/IEC 14496-5:2001), Harmonic and Individual Lines and Noise (HILN, MPEG-4 Parametric Audio Coding), MPEG-4 reference software (ISO/IEC 14496-5:2001), TwinVQ, MPEG-4 reference software (ISO/IEC 14496-5:2001), BSAC (Bit-Sliced Arithmetic Coding), MPEG-4 reference software (ISO/IEC 14496-5:2001), Musepack, Perceptual Audio Coding, QDesign, Siren 7, libg722_{—}1, libsiren (part of libmsn and msn-pecan), Siren 14, libg722_{—}1, Siren 22, TwinVQ, FFmpeg (decoder only), NTT TwinVQ Encoder, NTT TwinVQ Player, Vorbis, aoTuV, FFmpeg (decoder only without external library), libvorbis, Tremor, Windows Media Audio (WMA), Windows Media Encoder, Advanced Multi-Band Excitation (AMBE), Algebraic Code Excited Linear Prediction (ACELP), CDMA compression formats and codecs, Enhanced Variable Rate Codec (EVRC), Enhanced Variable Rate Codec B (EVRC-B), QCELP (Qualcomm Code Excited Linear Prediction), Selectable Mode Vocoder (SMV), Variable Multi Rate—WideBand (VMR-WB), CELT, Code Excited Linear Prediction (CELP), Continuously variable slope delta modulation (CVSD), Dialogic ADPCM (VOX), Digital Speech Standard (DSS), FS-1015 (LPC-10), FS-1016 (CELP), ITU standards:, G.711 (a-law and μ-law companding), also known as PCM of voice frequencies, FFmpeg (libavcodec), G.711.1, G.718, G.719, G.721 (superseded by G.726), G.722, G.722.1, G.722.2 (AMR-WB), 3GPP TS 26.173—AMR-WB speech Codec, opencore-amr (decoder), G.723 (24 and 40 kbit/s DPCM, extension to G.721, superseded by G.726), G.723.1 (MPC-MLQ or ACELP), G.726 (ADPCM), FFmpeg (libavcodec), G.728 (LD-CELP), G.729 (CS-ACELP), G.729a, G.729.1, GSM compression formats and codecs:, Full Rate (GSM 06.10), libgsm, Half Rate (GSM 06.20), Enhanced Full Rate (GSM 06.60), Adaptive Multi-Rate (AMR), AMR-NB, 3GPP TS 26.073—AMR speech Codec, opencore-amr, AMR-WB, 3GPP TS 26.173—AMR-WB speech Codec, opencore-amr (decoder), AMR-WB+, 3GPP TS 26.273—AMR-WB+ speech Codec, Harmonic Vector Excitation Coding (HVXC), Internet Low Bit Rate Codec (iLBC), Improved Multi-Band Excitation (IMBE), internet Speech Audio Codec (iSAC), Mixed Excitation Linear Prediction (MELP), Nellymoser Asao Codec, FFmpeg (libavcodec), PT716, PT716plus, PT724, Relaxed Code Excited Linear Prediction (RCELP), RTAudio, SILK—used by Skype, Speex, patent free, SVOPC—used by Skype, Triple Rate CODER (TRC) and Vector Sum Excited Linear Prediction (VSELP), and the like.

The one or more files 26 can include picture, video files, and the like, in various standard or non-standard formats, and for example, including Alpary, ArithYuv, AVIzlib, CamStudio GZIP, CorePNG, FastCodec, FFV1, Huffyuv, Lagarith, LCL, LOCO, LZO, MSU Lossless Video Codec, PICVideo, SheerVideo, Snow, TSCC TechSmith Screen Capture Codec, x264, ZMBV (Zip Motion Block Video) Codec, JPEG 2000—using the 5/3 filter for Lossless coding—intra-frame video coding, YULS, Audio Video Standard (AVS), OpenAVS, Blackbird FORscene video codec, Cineform, Cinepak, Dirac, Schrödinger, dirac-research, DV, Firebird Original FORscene video codec, H.261, FFmpeg H.261 (libavcodec), MPEG-1 Part 2 (MPEG-1 Video), Cinema Craft Encoder, FFmpeg, Ligos LSX MPEG-1, MainConcept MPEG-1, TMPGEnc, H.262/MPEG-2 Part 2 (MPEG-2 Video), Canopus ProCoder, Cinema Craft Encoder, Elecard MPEG-2 Video Decoder, FFmpeg, InterVideo Video Decoder, Ligos LSX MPEG-2, MainConcept MPEG-2, TMPGEnc, H.263, FFmpeg H.263 (libavcodec), MPEG-4 Part 2 (MPEG-4 Advanced Simple Profile), 3ivx, DivX, FFmpeg MPEG-4, HDX4, Nero Digital, Xvid, H.264/MPEG-4 AVC or MPEG-4 Part 10 (MPEG-4 Advanced Video Coding), CoreAVC, MainConcept, Nero Digital, QuickTime H.264, Sorenson AVC Pro codec, x264, Indeo 3/4/5, MJPEG, FFmpeg, Morgan Multimedia M-JPEG, Pegasus PICVideo M-JPEG, JPEG 2000 intra frame video codec, OMS Video, On2 Technologies TrueMotion VP3, VP4, VP5, VP6, VP7, VP8, TrueMotion S, TrueMotion 2, Pixlet, Apple ProRes 422, RealVideo, Snow Wavelet Codec, Sorenson Video, Sorenson Spark, Tarkin, Theora, FFmpeg, libtheora, TruDef high definition fractal video codec, VC-1 (SMPTE standard, subset of Windows Media Video), VC-3 SMPTE standard, Avid DNxHD, FFmpeg, Windows Media Video (WMV) and WAX (Part of the Windows Media Series), and the like.

The one or more files 28 can include documents, spreadsheets, presentation, personal information manager files, and the like, in various standard or non-standard formats, and for example, including ABW—AbiWord document, ACL—MS Word AutoCorrect List, AFP—Advanced Function Presentation—IBc, Amigaguide, ANS—ANSI text with Layout, ASC—ASCII text with Layout, AWW Ability Write, CSV—ASCII text encoded as Comma Separated Values, used in most spreadsheets such as Microsoft Excel or by most database management systems, CWK—ClarisWorks/AppleWorks document, DOC—Microsoft Word document, DOCX—Office Open XML Text document, DOT—Microsoft Word document template, DOTX—Office Open XML Text document template, EGT—EGT Universal Document, FTM—Fielded Text Meta, FTX—Fielded Text (Declared), HTML—HyperText Markup Language (.html, .htm), HWP—Haansoft Hangul Word Processor document, LWP—Lotus Word Pro, MCW—Microsoft Word for Macintosh (versions 4.0-5.1), NB—Mathematica Notebook, NBP—Mathematica Player Notebook, ODM—OpenDocument Master document, ODT—OpenDocument Text document, OTT—OpenDocument Text document template, PAGES—Apple Pages document, PAP—Papyrus word processor document, PDAX—Portable Document Archive (PDA) document index file, PDF—Portable Document Format, Radix-64, RTF—Rich Text document, SDW—StarWriter text document, used in earlier versions of StarOffice, STW—StarOffice/OpenOffice.org/NeoOffice text document template, SXW—StarOffice/OpenOffice.org/NeoOffice text document, TeX (.tex), Texinfo (.info), Troff, TXT—ASCII or Unicode plaintext, UOF—Uniform Office Format, UOML—UniqueObject Markup Language (UOML) is a XML-based markup language; uniqueobject.com, WPD—WordPerfect document, WPS—Microsoft Works document, WPT—Microsoft Works document template, WRD—WordIt! Document, WRF—ThinkFree Write, WRI—Microsoft Write document, XHTML (.xhtml, .xht) eXtensible Hyper-Text Markup Language, XML—eXtensible Markup Language, PMD—Adobe PageMaker, PUB—Microsoft Publisher, DVI, EGT Universal Document can be used to store css type styles (*.egt), PLD, PCL, PDF Portable Document Format, PostScript (.ps, .ps .gz), SNP—Microsoft Access Report Snapshot, XPS, XSL-FO (Formatting Objects), Configurations, Metadata, CSS, XSLT, XSL—XML Style Sheet (.xslt, .xsl), TPL—Web template (.tpl), KEY, KEYNOTE—Apple Keynote Presentation, NB—Mathematica Slideshow, NBP—Mathematica Player slideshow, ODP—OpenDocument Presentation, OTP—OpenDocument Presentation template, POT—Microsoft PowerPoint template, PPS—Microsoft PowerPoint Show, PPT—Microsoft PowerPoint Presentation, PPTX—Office Open XML Presentation, PRZ—Lotus Freelance Graphics, SDD—StarOffice's StarImpress, SHF—ThinkFree Show, SHW—Corel Presentations slide show creation, SSPSS—SongShow Plus Slide Show, STI—OpenOffice.org 1.* Presentation template, SXI—OpenOffice.org 1.* Presentation, WATCH—Dataton Watchout Presentation, 123—Lotus 1-2-3, AWS—Ability Spreadsheet, CLF—ThinkFree Calc, CSV—Comma-Separated Values, numbers—An Apple Numbers Spreadsheet file, gnumeric—Gnumeric spreadsheet, a gziped XML file, ODS—OpenDocument spreadsheet, OTS—OpenDocument spreadsheet template, QPW—Quattro Pro spreadsheet, SDC—StarOffice/OpenOffice.org StarCalc Spreadsheet, SLK—SYLK (SYmbolic LinK), STC—StarOffice/OpenOffice.org 1.* Spreadsheet template, SXC—StarOffice/OpenOffice.org 1.* Spreadsheet, TAB—tab delimited columns; also TSV (Tab-Separated Values), TXT—tab delimited columns, VC—Visicalc, WK1—Lotus 1-2-3 up to version 2.01, WK3—Lotus 1-2-3 version 3.0, WK4—Lotus 1-2-3 version 4.0, WKS—Lotus 1-2-3, WKS—Microsoft Works, WQ1—Quattro Pro DOS version, XLK—Microsoft Excel worksheet backup, XLS—Microsoft Excel worksheet sheet (97-2003), XLSB—Microsoft Excel binary workbook, XLSM—Microsoft Excel Macro-enabled workbook, XLSX—Office Open XML worksheet sheet, XLR—Microsoft Works version 6.0, XLT—Microsoft Excel worksheet template, XLTM—Microsoft Excel Macro-enabled worksheet template, XLW—Microsoft Excel worksheet workspace (version 4.0), MSG—Microsoft Outlook task manager, ORG—Lotus Organizer PIM package, PST—Microsoft Outlook e-mail communication, and SC2—Microsoft Schedule+ calendar, and the like.

The one or more files 30 can include game files, and the like, in various standard or non-standard formats, and for example, including HALO Engine—File formats used by games based on the Halo engine, MAP—A Level, User Interface, or Sounds, TAG—An Object, SAV—A saved game, LEV—A HALO ZERO Level, DOOM Engine—File formats used by games based on the DOOM engine, DEH—DeHackEd files to mutate the game executable (not officially part of the DOOM engine), DSG—Saved game, LMP—A lump is an entry in a DOOM wad, LMP—Saved demo recording, MUS—Music file (usually contained within a WAD file), WAD—Data storage (contains music, maps, and textures), Quake Engine—File formats used by games based on the Quake engine, BSP—(For Binary space partitioning) compiled map format, MAP—Raw map format used by editors like GtkRadiant or QuArK, MDL/MD2/MD3/MD5/GLM—Model for an item used in the game, PAK/PK2—Data storage, PK3/PK4—used by the Quake II, Quake III Arena and Quake 4 game engines, .dat general data contained within the .PK3/PK4 files, .fontdat a .dat file used for formatting game fonts, .roq—Video format, Unreal Engine—File formats used by games based on the Unreal engine., U—Unreal script format, UAX—Animations format for Unreal Engine 2, UMX—Map format for Unreal Tournament, UMX—Music format for Unreal Engine 1, UNR—Map format for Unreal, UPK—Package format for cooked content in Unreal Engine 3, USX—Sound format for Unreal Engine 1 and Unreal Engine 2, UT2—Map format for Unreal Tournament 2003 and Unreal Tournament 2004, UT3—Map format for Unreal Tournament 3, UTX—Music format for Unreal Engine 1 and Unreal Engine 2, UXX—Cache format, Duke Nukem 3D Engine—File formats used by games based on the Duke Nukem 3D engine., DMO—Save game, GRP—Data storage, MAP—Map (usually constructed with BUILD.EXE), Other Formats, B—used for Grand Theft Auto saved game files, BOL—used for levels on Poing!PC, DBPF—The Sims 2, DBPF, Package, GCF—format used by the Steam content management system for file archives, MAP—format used by Halo, POD—format used by Terminal Reality, REP—used by Blizzard Entertainment for scenario replays in StarCraft, Simcity 4, DBPF (.dat, .SC4Lot, .SC4Model), SMZIP—auto extractor for Stepmania songs themes and announcer packs, JAG,J64—Atari Jaguar (.jag, .j64), BIN—Wii (.bin), NDS—Nintendo DS (.nds), GB—Game Boy (.gb) (this applies to the original Game Boy and the Game Boy Color), GBC—Game Boy Color (.gbc), GBA—Game Boy Advance (.gba), GBA—Game Boy Advance (.gba), SAV—Game Boy Advance Saved Data Files (.sav), SGM—Visual Boy Advance Save States (.sgm), N64, V64, Z64, U64, USA, JAP, PAL, EUR, BIN—Nintendo 64 (.n64, .v64, .z64, .u64, .usa, .jap, .pal, .eur, .bin), PJ—Project 64 Save States (.pj), NES—Nintendo Entertainment System (.nes), FDS—Famicom Disk System (.fds), JST—Jnes Save States (.jst), GG—Sega Game Gear (.gg), SMS—Sega Master System (.sms), SMD,BIN—Mega Drive/Sega Genesis (.smd or .bin), SMC,078—Super NES (.smc, or 0.078) (0.078 is for split ROMs, which are rare), FIG—Super Famicom (Japanese releases are rarely .fig, above extensions are more common), SRM—Super NES Saved Data Files (.srm), ZST—ZSNES Save States (.zst, .zs1-.zs9), FRZ—Snes9X Save States (.frz), PCE—TurboGrafx-16/PC Engine (.pce), NPC—Neo Geo Pocket (.npc), TZX—ZX Spectrum (.tzx) (for exact copies of ZX Spectrum games), TAP (for tape images without copy protection), Z80,SNA—(for snapshots of the emulator RAM), DSK—(for disk images), TAP—Commodore 64 (.tap) (for tape images including copy protection), T64—(for tape images without copy protection, considerably smaller than .tap files), D64—(for disk images), CRT—(for cartridge images), ADF—Amiga (.adf) (for 880K diskette images), ADZ—GZip-compressed version of the above, and DMS—Disk Masher System, and the like.

The one or more files 32 can include web pages and content files, and the like, in various standard or non-standard formats, and for example, including HTML—(.html, .htm)—HyperText Markup Language, XHTML—(.xhtml, .xht)—eXtensible HyperText Markup Language, XML—(.xml), MHTML—(.mht, .mhtml)—Archived HTML, Dynamically generated, ASP—(.asp)—Microsoft Active Server Page, ASPX—(.aspx)—Microsoft Active Server Page .NET, ADP—AOLserver Dynamic Page, BML—(.bml)—Better Markup Language (templating), CFM—(.cfm)—ColdFusion, CGI—(.cgi), iHTML—(.ihtml)—Inline HTML, JSP—(.jsp) JavaServer Pages, Lasso—(.las, .lasso, .lassoapp), PL—Perl (.pl), PHP—(.php, .php?, .phtml)—? is version number, SSI—(.shtml)—HTML with Server Side Includes, SSI—(.stm)—HTML with Server Side Includes, and XML, markup language and other web standards-based file formats, and the like.

The one or more files 34 can include archive and compressed files, physical recordable media archiving files, databases files, and the like, in various standard or non-standard formats, and for example, including .?Q?—files compressed by the SQ program., 7z-7-Zip compressed file, ace—ACE compressed file, ALZ—Alzip compressed file, AT3—Sony's UMD Data compression, .bke—BackupEarth.com Data compression, ARC, ARJ—ARJ compressed file, BA—Scifer Archive (.ba), Scifer External Archive Type, big Special file compression format used by Electronic Arts for compressing the data for many of EA's games, BKF (.bkf)—Microsoft backup created by NTBACKUP.EXE, bzip2 (.bz2), bmp (paint), c4—JEDMICS image files, a DOD system, cab—Microsoft Cabinet, cals—JEDMICS image files, a DOD system, cpt/sea—Compact Pro (Macintosh), DAA—Closed-format, Windows-only compressed disk image, deb—Debian Linux install package, DMG—an Apple compressed/encrypted format, EEA—An encrypted CAB, ostensibly for protecting e-mail attachments, .egg—Alzip Egg Edition compressed file, EGT (.egt) EGT Universal Document also used to create compressed cabinet files replaces .ecab, ECAB (.ECAB, .ezip) EGT Compressed Folder used in advanced systems to compress entire system folders, ESS (.ess) EGT SmartSense File, GHO (.gho, .ghs)—Norton Ghost, gzip (.gz)—Compressed file, IPG (.ipg) Format in which Apple Inc. packages their iPod games, jar—ZIP file with manifest for use with Java applications, LBR—Library file, LQR—LBR Library file compressed by the SQ program., LHA (.lzh)—Lempel, Ziv, Huffman, lzo, lzma, lzx, MPQ Archives (.mpq)—Used by Blizzard games, MacBinary (.bin), PAK—Enhanced type of .ARC archive, Parchive (.par, .par2), Quake 3 archive (.pk3), Doom archive (.pk4), RAR Rar Archive (.rar), for multiple file archive (rar to .r01-.r99 to s01 and so on), SEN Scifer Archive (.sen), Scifer Internal Archive Type, sit/sitx—StuffIt (Macintosh), tar, .tar.gz, .tgz (gzipped tar file), TB (.tb)—Tabbery Virtual Desktop Tab file, TIB (.tib)—Acronis True Image backup, uha (Ultra High Archive Compression), VOL—unknown archive, VSA—Altiris Virtual Software Archive, Z—Unix compress file, zoo, zip, ISO—The generic file format for most optical media (CD-ROM, DVD-ROM, Blu-ray Disc, HD DVD and UMD), -Iso images indicate write directives, NRG—The proprietary optical media archive format used by Nero applications, IMG—For archiving MS-DOS formatted floppy disks, ADF—Amiga Disk Format, for archiving Amiga floppy disks, ADZ—The GZip-compressed version of ADF, DMS—Disk Masher System, a disk-archiving system native to the Amiga, DSK—For archiving floppy disks from a number of other platforms, D64—An archive of a Commodore 64 floppy disk., SDI—System Deployment Image, used for archiving and providing “virtual disk” functionality, MDF—Alcohol 120% CD Image File (Alcohol Software), DMG—Macintosh disk image files, ACCDB—Microsoft Database (Microsoft Office Access 2007), ADT—Advantage Database Server (ADS), APR—Lotus Approach data entry & reports, BOX—Lotus Notes Post Office mail routing database, DAF—Digital Anchor data file, DAT—DOS Basic, DB—Paradox, DBF—db/dbase (II,III,IV and V, Clipper, Harbour/xHarbour, Fox/FoxPro, Oracle), EGT—EGT Universal Document, ESS—EGT SmartSense, EAP—Enterprise Architect Project, FDB—Firebird Databases, FDB—Navision database file, FP, FP3, FP5, and FP7—FileMaker Pro, FRM—MySQL table definition, GDB—Borland InterBase Databases, KEXI—Kexi database file (SQLite-based), KEXIC—shortcut to a database connection for a Kexi databases on a server, LDB—Temporary database file, only existing when database is open, MDB (.mdb, .ldb)—Microsoft Database (Access), ADP—Microsoft Access project (used for accessing databases on a server), MDE—Compiled Microsoft Database (Access), MDF—Microsoft SQL Server Database, MYD—MySQL MyISAM table data, MYI—MySQL MyISAM table index, NCF—Lotus Notes configuration file, NSF—Lotus Notes database, NTF—Lotus Notes database design template, ODB—OpenOffice.org Base, ORA—Oracle tablespace files sometimes get this extension (also used for configuration files), PDB—Palm OS Database, PDI—Portable Database Image, PDX—Corel Paradox database management, PRC—Palm OS resource database, SQL—bundled SQL queries, REL—Sage Retrieve 4GL data file, RIN—Sage Retrieve 4GL index file, SDB—StarOffice's StarBase, UDL—Universal Data Link, WDB—Microsoft Works Database, MPP—Microsoft Project, AXD—cookie extensions found in temporary internet folder, BAK—backup file, CREDX—CredX Dat File, DUPX—DuupeCheck database management tool project file, GA3—Graphical Analysis 3, GED—GEDCOM, (GEnealogical Data COMmunication), IGC—flight tracks downloaded from GPS devices in the FAI's prescribed format, INI file—used by many applications to store configuration, KMC—tests made with KatzReview's MegaCrammer, LNK—Binary format file, stores shortcuts under MS Windows 95 and later, LSM—LSMaker script file (program using layered .jpg to create special effects, MPP—File format for Microsoft Project, POR—So called “portable” SPSS files, readable by PSPP, PXZ—Compressed file to exchange media elements with PSALMO, TOPC—TopicCrunch SEO Project file holding keywords, TOS—Character file from The Only Sheet, TMP—Temporary file, URL—INI format file, used by Internet Explorer to save Favorites, and ZED—My Heritage Family Tree, and the like.

The one or more files 36 on the memory and/or disk 14 can include information, and the like, about a list of advertisements, and the like, in the form of text, pictures, audio, video, and the like, to enable either the controller processor 20, or the additional processor(s) 40 to insert one or more advertisements at or before the time host device 10 is reading one of the files from among the files 24, 26, 28, 30, 32, or 34. Examples of the information available on the files 36, in addition to the actual advertisement content, can include metadata, tags, and the like, for each of the advertisements and also instructions on how often, what type and content of files, what usage patterns, with what frequency each advertisement is to be shown, and the like.

One or more files 38 and 42 can be provided on memory and/or disk 14, wherein the one or more files 38 can include analytics information, and the one or more files 42 can include tracking information, for example, that is extracted and/or generated by either the controller processor 20, and/or the additional processor(s) 40, at or after the time host device 10 is writing and/or reading one of the files among the files 24, 26, 28, 30, 32, and/or 34.

The files 36, 38, and 42 can all be part of a same file or a mixed set of files, a standard or a proprietary database, and the like. The location of the files 24, 26, 28, 30, 32, and 34 and the files 36, 38, and 42 can be combined or partitioned in various ways on one or more of the physical memories and/or disks 14. In an illustrative embodiment, the files 24, 26, 28, 30, 32, and 34 can be stored on one physical memory and/or disk 14, and the files 36, 38, and 42 can be stored on another memory and/or disk 14. Advantageously, this allows storing of user data and content in a separate memory and/or disk 14 than the advertisement related data and content.

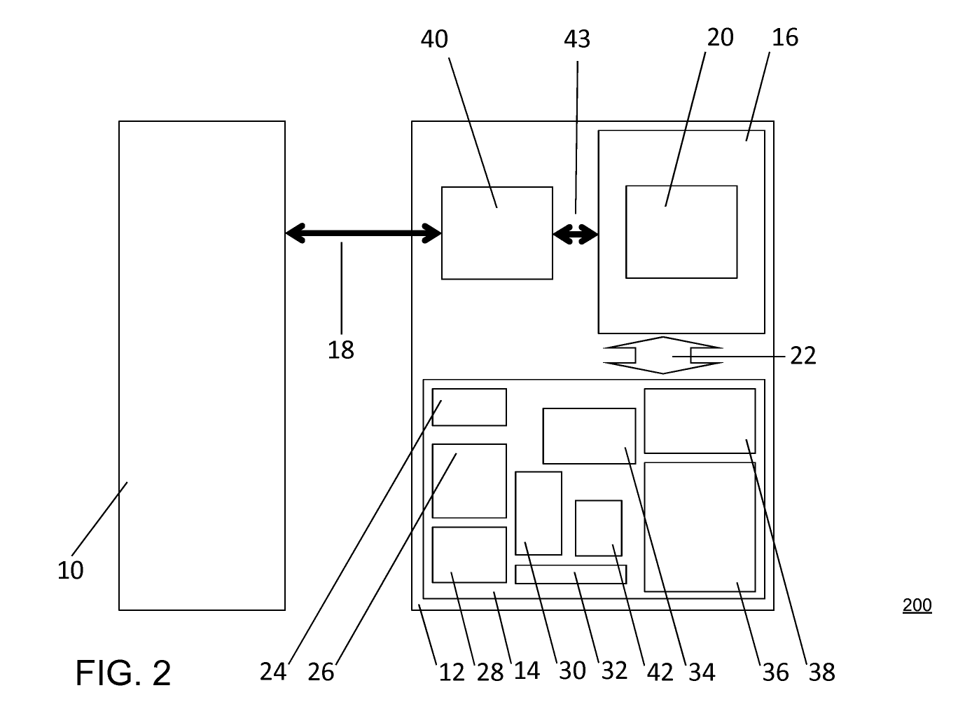

FIG. 2 is an illustrative system, method and apparatus for delivering advertisements via electronic data storage devices, and the like, according to a further illustrative embodiment. In FIG. 2, the illustrative system, method and apparatus 200 can be a variation of the system 100 of FIG. 1, wherein instead of having the processor 40 being part of the controller 16, the processor 40 is configured as an additional processor 40 in communication with the controller 16 via connection 43. The additional processor 40 can be added to the memory card 12 by locating the additional processor 40 between the controller 16 and the memory card 12 and coupled to the external connection 18. The additional processor 40 can interact with the controller 16 in a similar manner as the host device 10 interacts with the controller 16 in the system 100 of FIG. 1. Similarly, the additional processor 40 interacts with the host device 10 in a similar manner as the controller 16 interacts with the host device 16 in the system 100 of FIG. 1. Advantageously, the illustrative system, method and apparatus 200 of FIG. 2 enables use of all the available and usual components of the memory card 12, along with employing the additional processor 40 and connection 43 in the memory card 12.

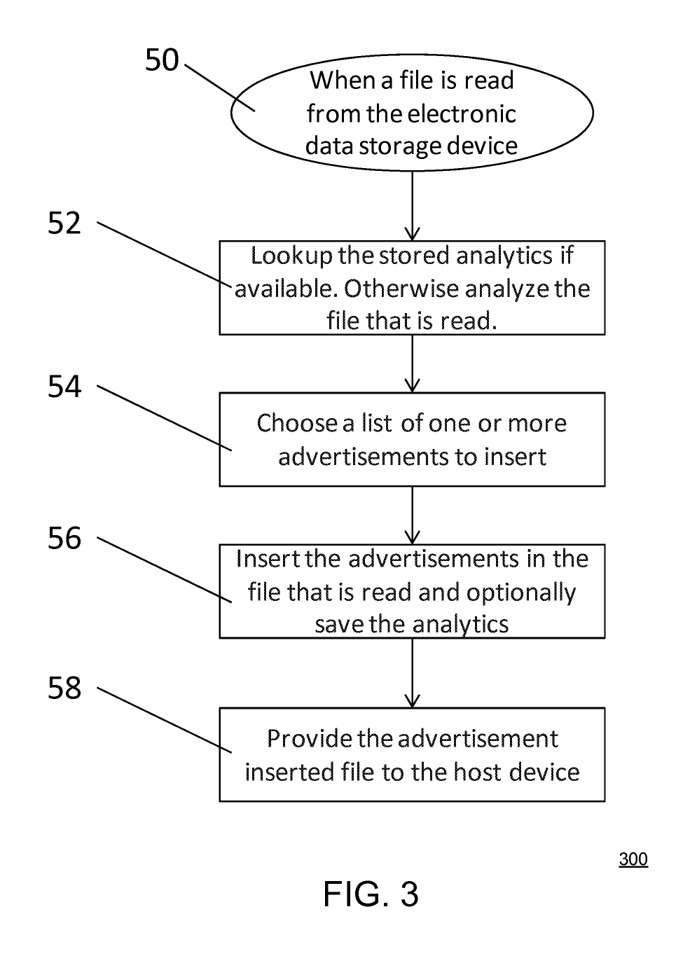

FIG. 3 is an illustrative flow chart 300 for a read process for a file on an electronic data storage device of the illustrative systems 100 and 200 of FIGS. 1-2. In FIG. 3, the method can be used for inserting advertisements at or before the time the host device 10 is reading one of the files from among the target files 24, 26, 28, 30, 32, and/or 34, and based on the one or more files 36. The method starts with step 50 each time a new target file on the memory and/or disk 14 is accessed by the host device 10.

In step 52, if any analytics data files 38 on the memory and/or disk 14 are available, the files 38 are accessed in step 52 by the processor 20 and/or 40 to help in the next steps. If such optional file 38 does not exist, the processor 20 and/or 40 can analyze the target file and detect the type of target file. Moreover, characteristics of the target file can be determined as the target file is pre-processed, and the characteristics can be saved in the file 38, or this can be done on the fly at read time. For example, any available metadata, tag, and the like, of the target file can be read and/or generated for the target file, such as a genre for a music file, and the like. Even if no metadata or tag is available for the target file, the processor 20 and/or 40 can be used to determine any suitable aspects of the target file, such as determining the genre of a music or video file from its name and/or by analyzing the target file music or video frames, and the like.

In step 54, a suitable program, and the like, for example, included in the file 36, and that runs on the processor 20 and/or 40, for example, based on the characteristics of the target file found in step 52 and the characteristics, metadata, tags, instructions, and the like, about of the advertisements available in the file 36, and track record information of the advertisements that are previously shown saved in the file 42, determines a list of target advertisements, including one or more advertisements, and the like, to show at specific times, in a specific manner, and the like, while the target file is read by the host device 10.

In step 56, the processor 20 and/or 40 inserts each of the target advertisements in the determined time and in a determined manner in the target file. The method to insert the target advertisements can depend on both the type of the target file from the files 24, 26, 28, 30, 32, or 34 and the target advertisement format available as part of file 36. For example, if the target file is one of the video or movie files 26 or the audio or music files 24, such files are frame based, and accordingly, in step 56 the processor 20 and/or 40 is configured to insert a frame of the target advertisement in between of the frames of the target file. In a further illustrative embodiment, step 56 can be used to overlay the content of the target advertisement on specific frames of the target file. In step 56, the processor 20 and/or 40 can optionally store the track record of the advertisement in the file 42. Examples of such a track record can include what target advertisement was shown and at what time inserted on what target file, and the like. Furthermore, the processor 20 and/or 40 can process the track record of the shown advertisements and update the file 38 with a set of analytics about the advertisements shown. The advertisements inserted or overlaid in the target file can be configured to be compliant with the original target file format, so as to work with the corresponding application on the host device 10, advantageously, without the host device 10 being able to stop the advertisements from being displayed as part of the target file.

In step 58, the target file including the inserted or overlaid target advertisement is provided to the host device 10 so that the host device 10 reads the target file with the inserted or overlaid target advertisements. The host device 10 need not know anything about the target advertisement and/or collaborate for the target advertisement to be shown when the target file is playing. Steps 56 and 58 can be combined and/or performed in any suitable order, and the like. For example, the delivery of the target advertisement inserted or overlaid in the target file can be done in various ways, for example, including providing the target file to the host device 10 at read time, in real or near real time, as each segment, packet, or set of frames of the target file is read, or by buffering a predetermined amount of the target advertisement inserted or overlaid in the target file before making the buffer available for the host device 10 to read, or by first writing the target advertisement inserted or overlaid in the target file on the electronic data storage device 12 before it is read by the host device 10, and the like. There can be a tradeoff between memory footprint and speed that in some cases makes it more suitable to have a buffer or to preprocess the target advertisement inserted or overlaid in the target file before making the buffer available for the host device 10 to read. The target advertisement inserted or overlaid on the target file continues to be compliant with the file format of the original target file so as to work with the corresponding application on the host device 10. In cases where the original target file is not compatible with the host device 10, the original target file, advantageously, can be transcoded, adapted, and the like, in steps 56 and/or 58 by the processor 20 and/or 40 to allow playback on the host device 10.

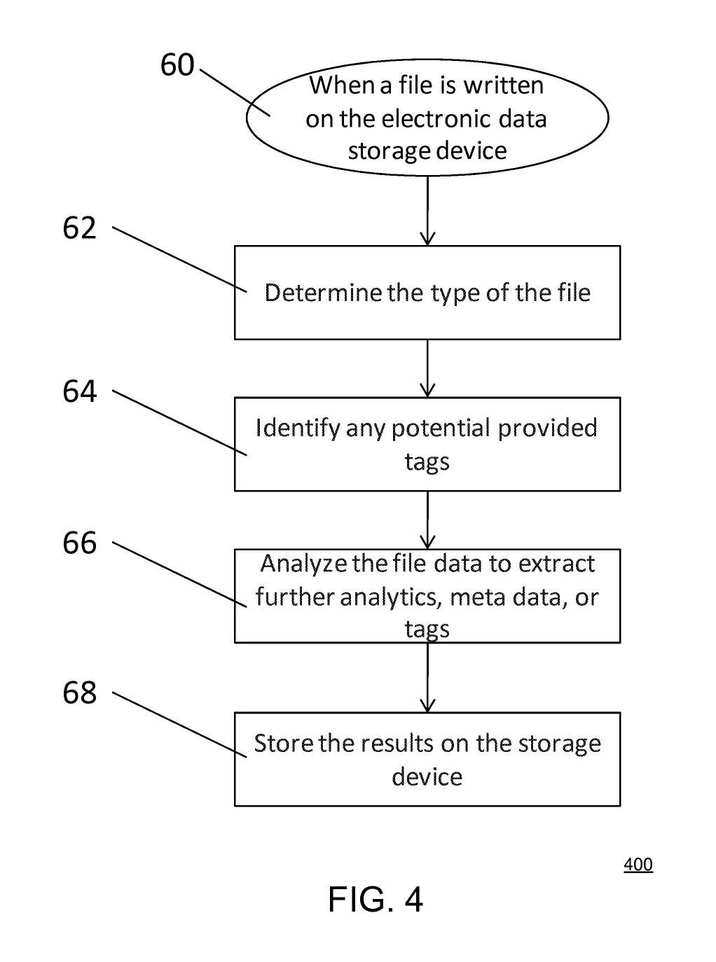

FIG. 4 is an illustrative flow chart 400 for a write process for a file on an electronic data storage device of the illustrative systems 100 and 200 of FIGS. 1-2. In FIG. 4, a method is illustrated for analyzing any of the files 24, 26, 28, 30, 32, or 34 at the time they are written into the electronic data storage device 12 by the host device 10. This method can be optional, since the method described in FIG. 3 still can work even if the method of FIG. 4 is not performed. However, if the method in FIG. 4 is executed at the time or after each of the files 24, 26, 28, 30, 32, or 34 is written into the electronic data storage device 12 at step 60, but before they are read by the host device 10, advantageously, this provides more time available to do a more detailed analysis by the processors 20 and/or 40. At step 62, the processor 20 and/or 40 can determine the type of target file being written. Moreover, the characteristics of the written target file can be determined at step 66 and saved in the file 38. For example, if any metadata or tag is available for the written target file, as determined at step 64, such information can be read and stored in the file 38 (e.g., such as the genre if the target file is a music file). Even if no metadata or tag is available, as determined at step 64, the processor 20 and/or 40 can be configured at step 66 to determine any suitable aspects of the target file, for example, including determining the genre of a music or video file from its name and/or by analyzing the written files music or video frames, and the like. In step 68, the result of the analysis by the processor 20 and/or 40 is saved in the file 38, for example, for later use by the method of FIG. 3.

Advantageously, the present disclosure enables the processing used to choose and insert or overlay target advertisements into target file or files 24, 26, 28, 30, 32, or 34, and the processing used for analytics to be done inside the slave electronics data storage device 12 rather than the host device 10. In addition, the present disclosure enables advanced advertisement methodologies, such augmented reality, and the like, by leveraging the processors 20 and/or 40 inside the electronic data storage device 10, for example, to overlay context sensitive target advertisement information into the file or files 24, 26, 28, 30, 32, or 34.

Further, the present disclosure enables partially or fully subsidizing the price of the target advertisement enabled on the electronic data storage device 12, for example, based on the target advertisements revenue. Another possibility is to provide cash back for including target advertisement enabled electronic data storage devices 12. The provider of the advertisement enabled electronic data storage device 12 can optionally provide the means for the users to return the electronic data storage device 12 and receive new electronic data storage devices 12 with new advertisement or to recharge an electronic data storage device 12 with new target advertisements. In these cases, information regarding usage pattern of users can be used by the provider to further personalize the package of advertisements to be loaded on the electronic data storage device 12.

The above-described devices and subsystems of the illustrative embodiments of FIGS. 1-4 can include, for example, any suitable servers, workstations, PCs, laptop computers, PDAs, Internet appliances, handheld devices, cellular telephones, wireless devices, other electronic devices, and the like, capable of performing the processes of the illustrative embodiments of FIGS. 1-4. The devices and subsystems of the illustrative embodiments of FIGS. 1-4 can communicate with each other using any suitable protocol and can be implemented using one or more programmed computer systems or devices.

One or more interface mechanisms can be used with the illustrative embodiments of FIGS. 1-4, including, for example, Internet access, telecommunications in any suitable form (e.g., voice, modem, and the like), wireless communications media, and the like. For example, employed communications networks or links can include one or more wireless communications networks, cellular communications networks, cable communications networks, satellite communications networks, G3 communications networks, Public Switched Telephone Network (PSTNs), Packet Data Networks (PDNs), the Internet, intranets, WiMax Networks, a combination thereof, and the like.

It is to be understood that the devices and subsystems of the illustrative embodiments of FIGS. 1-4 are for illustrative purposes, as many variations of the specific hardware and/or software used to implement the illustrative embodiments are possible, as will be appreciated by those skilled in the relevant art(s). For example, the functionality of one or more of the devices and subsystems of the illustrative embodiments of FIGS. 1-4 can be implemented via one or more programmed computer systems or devices.

To implement such variations as well as other variations, a single computer system can be programmed to perform the special purpose functions of one or more of the devices and subsystems of the illustrative embodiments of FIGS. 1-4. On the other hand, two or more programmed computer systems or devices can be substituted for any one of the devices and subsystems of the illustrative embodiments of FIGS. 1-4. Accordingly, principles and advantages of distributed processing, such as redundancy, replication, and the like, also can be implemented, as desired, to increase the robustness and performance the devices and subsystems of the illustrative embodiments of FIGS. 1-4.

The devices and subsystems of the illustrative embodiments of FIGS. 1-4 can store information relating to various processes described herein. This information can be stored in one or more memories, such as a hard disk, optical disk, magneto-optical disk, RAM, and the like, of the devices and subsystems of the illustrative embodiments of FIGS. 1-4. One or more databases of the devices and subsystems of the illustrative embodiments of FIGS. 1-4 can store the information used to implement the illustrative embodiments of the present disclosure. The databases can be organized using data structures (e.g., records, tables, arrays, fields, graphs, trees, lists, and the like) included in one or more memories or storage devices listed herein. The processes described with respect to the illustrative embodiments of FIGS. 1-4 can include appropriate data structures for storing data collected and/or generated by the processes of the devices and subsystems of the illustrative embodiments of FIGS. 1-4 in one or more databases thereof.

All or a portion of the devices and subsystems of the illustrative embodiments of FIGS. 1-4 can be conveniently implemented using one or more general purpose computer systems, microprocessors, digital signal processors, micro-controllers, application processors, domain specific processors, application specific signal processors, and the like, programmed according to the teachings of the illustrative embodiments of the present disclosure, as will be appreciated by those skilled in the computer and software arts. Appropriate software can be readily prepared by programmers of ordinary skill based on the teachings of the illustrative embodiments, as will be appreciated by those skilled in the software art. In addition, the devices and subsystems of the illustrative embodiments of FIGS. 1-4 can be implemented by the preparation of application-specific integrated circuits or by interconnecting an appropriate network of conventional component circuits, as will be appreciated by those skilled in the electrical art(s). Thus, the illustrative embodiments are not limited to any specific combination of hardware circuitry and/or software.

Stored on any one or on a combination of computer readable media, the illustrative embodiments of the present disclosure can include software for controlling the devices and subsystems of the illustrative embodiments of FIGS. 1-4, for driving the devices and subsystems of the illustrative embodiments of FIGS. 1-4, for enabling the devices and subsystems of the illustrative embodiments of FIGS. 1-4 to interact with a human user, and the like. Such software can include, but is not limited to, device drivers, firmware, operating systems, development tools, applications software, and the like. Such computer readable media further can include the computer program product of an embodiment of the present disclosure for performing all or a portion (if processing is distributed) of the processing performed in implementing the illustrative embodiments of FIGS. 1-4. Computer code devices of the illustrative embodiments of the present disclosure can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the illustrative embodiments of the present disclosure can be distributed for better performance, reliability, cost, and the like.

As stated above, the devices and subsystems of the illustrative embodiments of FIGS. 1-4 can include computer readable medium or memories for holding instructions programmed according to the teachings of the present disclosure and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave, or any other suitable medium from which a computer can read.

While the present invention has been described in connection with a number of illustrative embodiments and implementations, the present invention is not so limited, but rather covers various modifications and equivalent arrangements, which fall within the purview of the appended claims.

What is claimed is:

1. A system for delivering advertisements via electronic data storage devices, the system comprising:
an electronic data storage device, including a memory, a controller processor, and a pre-loaded target advertisement; and
a host device coupled to the electronic data storage device,
wherein the controller processor is configured to deliver the target advertisement to the host device by inserting or overlaying the target advertisement in a target file as the host device reads the target file from the electronic data storage device.

2. The system of claim 1, wherein the target advertisement is one of a text file, a picture file, an audio file, and a video file, and the target file is one of a document file, a picture file, an audio file, a music file, a video file, and a game file.

3. The system of claim 1, wherein a processor of the host device is not used for the inserting or the overlaying of the target advertisement in the target file.

4. The system of claim 1, wherein the target advertisement inserted or overlaid in the target file is compliant with a file format of the target file and if the target file is not compatible with the host device, the controller processor is configured to transcode the target file to allow playback on the host device.

5. The system of claim 1, wherein the controller processor is configured to analyze the target file to determine one of metadata, and tags for the target file.

6. The system of claim 1, wherein an additional processor instead of the controller processor is provided and configured to deliver the target advertisement to the host device by inserting or overlaying the target advertisement in a target file as the host device reads the target file from the electronic data storage device.

7. A method for delivering advertisements via electronic data storage devices, the method comprising:
coupling a host device to an electronic data storage device having a memory, a controller processor, and a pre-loaded target advertisement; and
delivering by the controller processor the target advertisement to the host device by inserting or overlaying the target advertisement in a target file as the host device reads the target file from the electronic data storage device.

8. The method of claim 7, wherein the target advertisement is one of a text file, a picture file, an audio file, and a video file, and the target file is one of a document file, a picture file, an audio file, a music file, a video file, and a game file.

9. The method of claim 7, wherein a processor of the host device is not used for the inserting or the overlaying of the target advertisement in the target file.

10. The method of claim 7, wherein the target advertisement inserted or overlaid in the target file is compliant with a file format of the target file and if the target file is not compatible with the host device, the controller processor is configured to transcode the target file to allow playback on the host device.

11. The method of claim 7, further comprising analyzing by the controller processor the target file to determine one of metadata, and tags for the target file.

12. The method of claim 7, further comprising delivering by an additional processor instead of the controller processor the target advertisement to the host device by inserting or overlaying the target advertisement in a target file as the host device reads the target file from the electronic data storage device.

13. A computer program product for delivering advertisements via electronic data storage devices, and including one or more computer readable instructions embedded on a computer readable medium and configured to cause one or more computer processors to perform the steps of:
coupling a host device to an electronic data storage device having a memory, a controller processor, and a pre-loaded target advertisement; and
delivering by the controller processor the target advertisement to the host device by inserting or overlaying the target advertisement in a target file as the host device reads the target file from the electronic data storage device.

14. The computer program product of claim 13, wherein the target advertisement is one of a text file, a picture file, an audio file, and a video file, and the target file is one of a document file, a picture file, an audio file, a music file, a video file, and a game file.

15. The computer program product of claim 13, wherein a processor of the host device is not used for the inserting or the overlaying of the target advertisement in the target file.

16. The computer program product of claim 13, wherein the target advertisement inserted or overlaid in the target file is compliant with a file format of the target file and if the target file is not compatible with the host device, the controller processor is configured to transcode the target file to allow playback on the host device.

17. The computer program product of claim 13, further comprising analyzing by the controller processor the target file to determine one of metadata, and tags for the target file.

18. The computer program product of claim 13, further comprising delivering by an additional processor instead of the controller processor the target advertisement to the host device by inserting or overlaying the target advertisement in a target file as the host device reads the target file from the electronic data storage device.
